(19) United States
(12) Patent Application Publication
(10) Pub. No.: US 2013/0128593 A1
(43) Pub. Date: May 23, 2013

(54) PORTABLE ELECTRONIC DEVICE

(71) Applicant: JIAN-WEI LUO, Shenzhen City (CN)

(72) Inventor: JIAN-WEI LUO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/483,253

(22) Filed: May 30, 2012

(30) Foreign Application Priority Data
Nov. 22, 2011 (CN) 201110373425.3

(51) Int. Cl. F21V 15/00

(52) U.S. Cl. 362/362

(57) ABSTRACT

A portable electronic device includes a housing portion, a number of light emitted diodes (LEDs) received in the housing portion, and an anti-static structure. The housing portion defines a plurality of through holes. The anti-static structure is positioned between the housing portion and the LEDs, and defines a plurality of recesses corresponding to the through holes. The anti-static structure is made from anti-static and transparent material; the LEDs are separated from the housing portion by the anti-static structure. Each LED is received within the corresponding recess, static charges on the housing portion are discharged to ground, and the light emitted from the LEDs is emitted out of the portable electronic device along the recesses, the anti-static structure, and through the through holes for user observation.

### BACKGROUND

1. Technical field

The disclosure generally relates to portable electronic devices, particularly to a portable electronic device with an anti-static structure.

2. Description of the Related Art

Light emitting diodes (LEDs) are usually embedded within housings of portable electronic devices (e.g., computers) and are partially exposed from the housing to indicate to an observer different operating states of the portable electronic device. To ensure the quality of the portable electronic devices, static testing of the portable electronic devices is necessary. However, static electricity on the surface of the housing may be emitted to the cathode pin and the anode pin of each LED during the static testing, which may damage the LED and fail to complete the static testing.

Therefore, there is room for improvement within the art.

### BRIEF DESCRIPTION OF THE DRAWINGS

Many aspects of a portable electronic device can be better understood with reference to the following drawings. The components in the drawings are not necessarily drawn to scale, the emphasis instead being placed upon clearly illustrating the principles of the portable electronic device. Moreover, in the drawings, like reference numerals designate corresponding parts throughout the several views. Wherever possible, the same reference numbers are used throughout the drawings to refer to the same or like elements of an embodiment.

FIG. 1 is a partially assembled view of an exemplary embodiment of a portable electronic device including an anti-static structure of the disclosure.

FIG. 2 is similar to FIG. 1, but shown from another angle.

FIG. 3 is a schematic view of the anti-static structure shown in FIG. 1 of the disclosure.

FIG. 4 is a cross-sectional view of the anti-static structure taken along line IV-IV shown in FIG. 3 of the disclosure.

### DETAILED DESCRIPTION

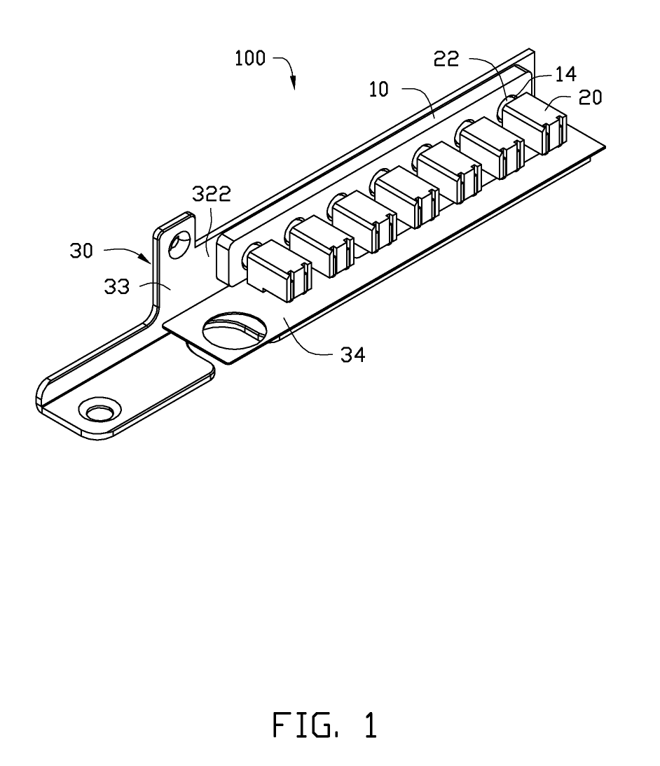

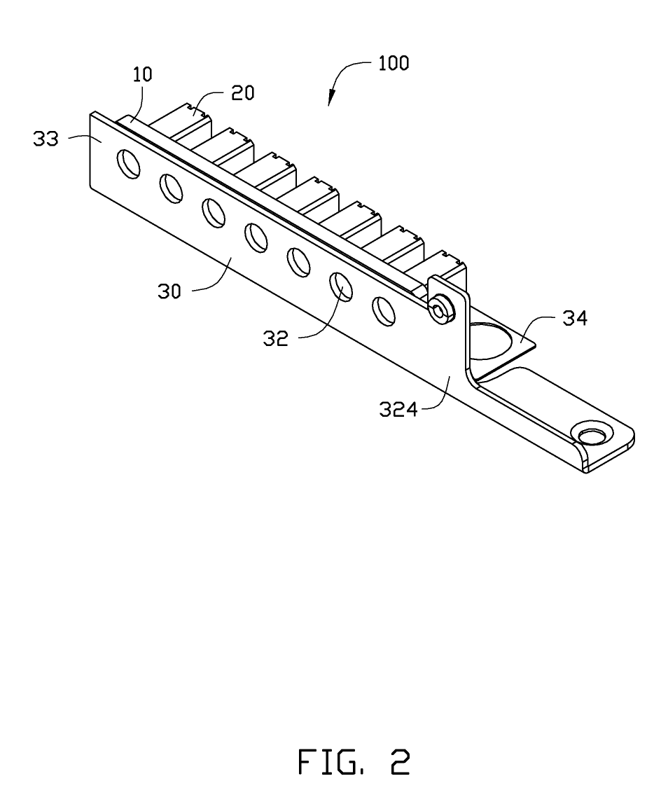

FIG. 1 is a partially assembled view of an exemplary embodiment of a portable electronic device 100 including an anti-static structure 10 of the disclosure. FIG. 2, illustrates the portable electronic device 100 further includes a plurality of light emitted diodes (LEDs) 20 and a housing portion 30.

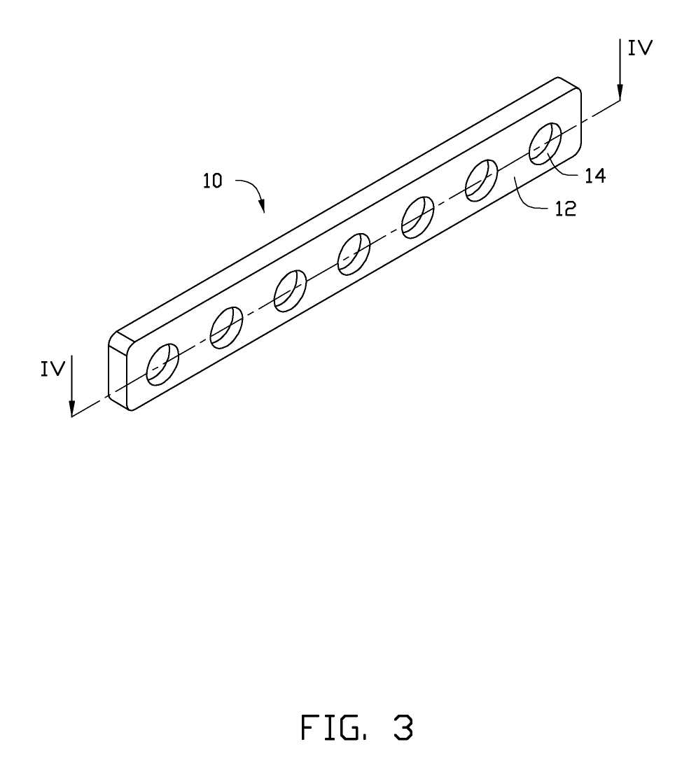

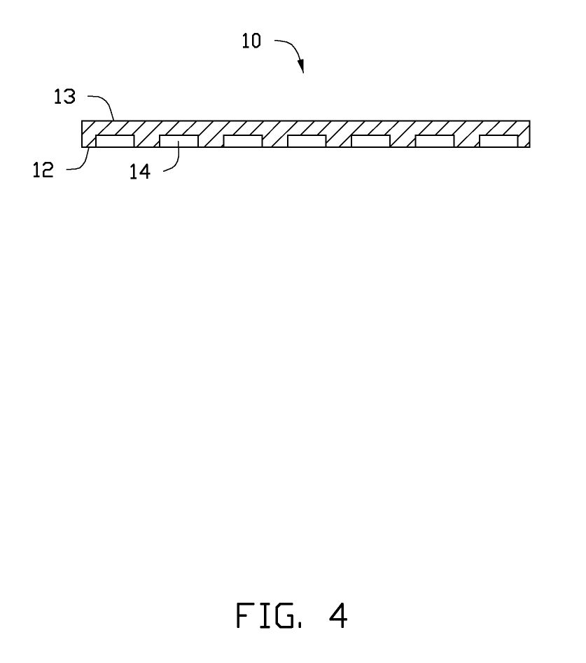

FIGS. 3 and 4, illustrate the anti-static structure 10 is substantially a rectangular plate and includes a first surface 12 and a second surface 13 opposite to the first surface 12. The first surface 12 defines a plurality of spaced-apart recesses 14. The depth of each recess 14 is about half of the thickness of the anti-static structure 10, therefore forming a receiving space in each recess 14. In an exemplary embodiment, the anti-static structure 10 can be made from polycarbonate, polyvinyl chloride, polyethylene terephthalate diethyl or other anti-static materials, so the anti-static structure 10 has good anti-static and high light transparency properties.

FIG. 2, shows the housing portion 30 as one part of the housing of the portable electronic device 100, and defines a plurality of through holes 32. Each through hole 32 is aligned with a corresponding LED 20. The anti-static structure 10 is positioned between the housing portion 30 and the plurality of LEDs 20, so the anti-static structure 10 can avoid the LEDs 20 being directly exposed out of the surface of the housing portion 30, and can conduct the light emitted from the LEDs 20 to the housing portion 30. Thus, the light from LEDs 20 is emitted out and visible through the through holes 32.

In an exemplary embodiment, the housing portion 30 includes a sidewall 33 and a bottom wall 34 perpendicular to the sidewall 33. The plurality of through holes 32 are arranged in the sidewall 33 and aligned with the LEDs 20 respectively. The LEDs 20 are supported by the bottom wall 34. The LEDs 20 each includes a plastic lens 22, and each plastic lens 22 is aligned with a corresponding through hole 32, so the light from the LEDs 20 can be emitted outside the housing portion 30 via the through holes 32.

The anti-static structure 10 is detachably supported by the bottom plate 34, and the second surface 13 contacts the inner surface 322 of the sidewall 33. Each recess 14 is aligned with the corresponding through hole 32, and each plastic lens 22 is received within the corresponding recess 14 of the anti-static structure 10. Therefore, when the various LEDs 20 emit light, the light is emitted out of the portable electronic device 100 through the recesses 14 and the through holes 32 for user observation.

In static testing, since the anti-static structure 10 is positioned between the LEDs 20 and the housing portion 30, so the LEDs 20 are separated from the housing portion 30 by the anti-static structure 10. Thus, the static charges on the surface of the housing portion 30 are conducted to ground through the housing portion 30, but not emitted to the LEDs 20, which can protect the LEDs 20 from static damage. Additionally, the light from the LEDs 20 can be emitted out of the portable electronic device 100 along the recesses 14, the transparent anti-static structure 100 and through the through holes 32 for user observation.

In summary, in the portable electronic device 100 of the disclosure, the anti-static structure 10 is positioned between the LEDs 20 and the housing portion 30, so that the LEDs 20 are separated from the housing portion 30 by the insulated and transparent anti-static structure 10. Thus, the static charges on the housing portion 30 will be directly conducted to ground through the housing portion 30, but not to the LEDs 20 during static testing, which can protect the LEDs 20 and facilitate normal test operations. Moreover, due to the high light transparency of the anti-static structure 10, the light from the LEDs 20 can be emitted out of the portable electronic device 100 along the transparent anti-static structure 10 and through the through holes 32 for observing the operating states of the portable electronic device 100.

In the present specification and claims, the word “a” or “an” preceding an element does not exclude the presence of a plurality of such elements. Further, the word “comprising” does not exclude the presence of elements or steps other than those listed.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of this exemplary disclosure to the full extent indicated by the broad general meaning of the terms in which the appended claims are expressed.

What is claimed is:

1. A portable electronic device, comprising:
a housing portion defining a plurality of through holes;
a plurality of light emitted diodes (LEDs) received within the housing portion; and
a transparent anti-static structure;
wherein the anti-static structure is positioned between the housing portion and the plurality of LEDs, each LED is aligned with a corresponding through hole, and the light from the LEDs is emitted out and visible through the anti-static structure and the through holes.

2. The portable electronic device as claimed in claim 1, wherein the anti-static structure comprises a first surface and a second surface opposite to the first surface, the first surface defines a plurality of spaced-apart recesses.

3. The portable electronic device as claimed in claim 2, wherein the depth of each recess is about half of the thickness of the anti-static structure to form a receiving space in the recess.

4. The portable electronic device as claimed in claim 1, wherein the anti-static structure is made from any of polycarbonate, polyvinyl chloride, and polyethylene terephthalate diethyl.

5. The portable electronic device as claimed in claim 2, wherein the housing portion comprises a sidewall and a bottom wall perpendicular to the sidewall, the plurality of through holes are arranged in the sidewall and aligned with the LEDs respectively, and the LEDs are supported by the bottom wall.

6. The portable electronic device as claimed in claim 5, wherein the anti-static structure is detachably supported by the bottom plate, each recess is aligned with a corresponding through hole, and each plastic lens is received within the corresponding recess of the anti-static structure, and the LEDs emit light, the light is emitted out of the portable electronic device through the recesses and the through holes for user observation.

7. The portable electronic device as claimed in claim 1, wherein each LED comprises a plastic lens, each plastic lens is aligned with a corresponding through hole, and the light emitted from the LEDs is emitted outside the housing portion via the through holes.

8. A portable electronic device, comprising:
a housing portion defining a plurality of through holes;
a plurality of light emitted diodes (LEDs) received within the housing portion; and
an anti-static structure positioned between the housing portion and the plurality of LEDs and defining a plurality of recesses corresponding to the through holes;
wherein the anti-static structure is made from anti-static and transparent material, the LEDs are separated from the housing portion by the anti-static structure, each LED is received within the corresponding recess, static charges on the housing portion are discharged to ground, and the light emitted from the LEDs is emitted out of the portable electronic device along the recesses, and visible through the anti-static structure, and the through holes.

9. The portable electronic device as claimed in claim 8, wherein the anti-static structure comprises a first surface and a second surface opposite to the first surface, and the plurality of recesses are defined on the first surface.

10. The portable electronic device as claimed in claim 9, wherein the depth of each recess is about half of the thickness of the anti-static structure to form a receiving space in the recess.

11. The portable electronic device as claimed in claim 8, wherein the anti-static structure is made from any of polycarbonate, polyvinyl chloride, and polyethylene terephthalate diethyl.

12. The portable electronic device as claimed in claim 8, wherein the housing portion comprises a sidewall and a bottom wall perpendicular to the sidewall, the plurality of through holes are arranged in the sidewall and aligned with the LEDs respectively, and the LEDs are supported by the bottom wall.

13. The portable electronic device as claimed in claim 12, wherein the anti-static structure is detachably supported by the bottom plate, each recess is aligned with a corresponding through hole, and each plastic lens is received within the corresponding recess of the anti-static structure, and the LEDs emit light, the light is emitted out of the portable electronic device via the recesses and the through holes for user observation.

14. The portable electronic device as claimed in claim 8, wherein each LED comprises a plastic lens, each plastic lens is aligned with a corresponding through hole, and the light emitted from the LEDs is emitted outside the housing portion via the through holes.

15. A housing structure for a portable electronic device, the portable electronic device including a plurality of light emitted diodes (LEDs), the housing structure comprising:
a housing portion defining a plurality of through holes corresponding to the LEDs; and
a transparent anti-static structure;
wherein the anti-static structure is positioned adjacent the housing portion and the light from the LEDs is emitted out of the portable electronic device through the anti-static structure and visible through the through holes.

16. The housing structure as claimed in claim 15, wherein the anti-static structure is positioned between the housing portion and the LEDs and comprises a first surface and a second surface opposite to the first surface, and the plurality of recesses are defined on the first surface.

17. The housing structure as claimed in claim 16, wherein the depth of each recess is about half of the thickness of the anti-static structure to form a receiving space in the recess.

18. The housing structure as claimed in claim 15, wherein the anti-static structure is made from any of polycarbonate, polyvinyl chloride, and polyethylene terephthalate diethyl.

19. The housing structure as claimed in claim 15, wherein the housing portion comprises a sidewall and a bottom wall perpendicular to the sidewall, the plurality of through holes are arranged in the sidewall and aligned with the LEDs respectively, and the LEDs are supported by the bottom wall.

20. The housing structure as claimed in claim 19, wherein the anti-static structure is detachably supported by the bottom plate, each recess is aligned with a corresponding through hole, and each plastic lens is received within the corresponding recess of the anti-static structure, and the LEDs emit light, the light is emitted out of the portable electronic device via the recesses and the through holes for user observation.
